(19) United States
(12) Patent Application Publication
(10) Pub. No.: US 2005/0034446 A1
(43) Pub. Date: Feb. 17, 2005

(54) Dual capture jet turbine and steam generator

(76) Inventor: William Sheridan Fielder, Ojai, CA (US)

Correspondence Address: WILLIAM S. FIELDER, P.O. BOX 1221, OJAI, CA, 93024-1221, US

(21) Appl. No.: 10/916,346

(22) Filed: Aug. 10, 2004

Related U.S. Application Data
(60) Provisional application No. 60/494,186, filed on Aug. 11, 2003.

(51) Int. Cl. F02C 3/22

(52) U.S. Cl. 60/39.465

(57) ABSTRACT

An energy capture system to capture the heat and thrust produced from a hydrogen and oxygen reaction. This is accomplished by means of heat exchangers and turbines. It is intended to replace steam generators that rely on fossil fuels and uranium and used in electric power plants. This invention also provides for the capture of the water produced, from the said reaction, and may be used to supplement or completely supply a community's water requirements.

### CROSS-REFERENCE TO RELATED APPLICATIONS

This application claims benefit of Provisional Application Ser. No. 60/494,186 filed Aug. 11, 2003 by the present inventor.

### FEDERALLY SPONSORED RESEARCH

None

### BACKGROUND OF INVENTION—FIELD OF INVENTION

This invention generally relates to the field of hydrogen combustion systems; specifically it relates to electricity and steam generation, water recovery, and energy capture systems.

### BACKGROUND OF INVENTION—PRIOR ART

Currently the steam generators used in electric power plants rely on hydrocarbon based fuels or uranium.

The negative externalities associated with hydrocarbon based fuels includes but is not limited to: “greenhouse gases”, mercury poisoning, oil spills, and limited availability that threatens our national security and economic stability.

The negative externalities associated with uranium based fuels include but are not limited to: the long-term health risks associated with accidental exposure, toxic byproducts with half-lives ranging into the millions of years, national security and environmental issues associated with transporting nuclear waste, and long-range waste storage solutions.

Fuel cells have been seen by many as the means to replace these toxic energy sources. However fuel cells have their own limitations as compared to this invention. Limitations associated with Proton Exchange Membrane fuel cells, or PEM, the most developed of the available fuel cells, include but are not limited to: fuel cell cores that are expensive to build and maintain, and complex heat and water management. Phosphoric Acid fuel cells used in medium to large-scale power generation suffer from: low efficiency, limited service life and an expensive catalyst. Solid Oxide fuel cells, also suitable for medium to large-scale power generation are limited by: high operating temperatures, exotic metals, high manufacturing costs, oxidation issues and low specific power.

### OBJECTS AND ADVANTAGES

Accordingly, several objects and advantages of this invention are:

a. a readily available supply of energy to fire the steam generators commonly found in electric power plants, in an environmentally friendly manner;

b. affordable cost to build and maintain;

c. this invention also supplements or entirely provides for a community's water supply by providing a means for water collection, and for the independent operation of the water management facilities;

d. further objects and advantages will become apparent from a consideration of the ensuing description and drawings.

### SUMMARY

An embodiment of the invention includes a combustion chamber for a hydrogen and oxygen reaction, for the purpose of capturing the resultant heat and thrust, as well as the water produced. Heat is captured by one, or possibly multiple heat exchangers and transformed into rotational energy by a turbine that powers an electric generator. Thrust is captured by a turbine and transformed into electrical energy by an electric generator. The energy captured is intended to replace that which is currently used to fire steam generators in electric power plants and the water produced is intended to supplement or entirely provide for a communities water supply.

### DRAWINGS—FIGURES

FIG. 1 illustrates the preferred embodiment: a combustion chamber including both interior and exterior heat exchanges, together with an external turbine and a water management system means.

FIG. 2 shows a combustion chamber with only an interior heat exchanger and an external turbine together with a water management system means.

FIG. 3 shows a combustion chamber with only an exterior heat exchanger and an external turbine including a water management system means.

FIG. 4 shows a combustion chamber with a plurality of oxygen and hydrogen injector pairs.

FIG. 5 shows a combustion chamber with the heat exchangers installed adjacent to and covering the combustion chamber. Attached to the exterior heat exchanger is a turbine with attached water management system means.

FIG. 6 shows a combustion chamber with the heat exchangers installed adjacent to and covering the combustion chamber in multiple layers. Attached is a turbine and water management system means.

### DRAWINGS—REFERENCE NUMERALS

| | | | |
|---|---|---|---|
| 1 | Dual Capture Jet Turbine | 2 | combination chamber |
| 3 | hydrogen injector | 4 | oxygen injector |
| 5 | exterior heat exchanger | 6 | water injector |
| 7 | steam exhaust conduit to turbine | 8 | interior heat exchanger |
| 9 | water injector | 10 | steam exhaust conduit to |
| | | | turbine |
| 11 | nozzle | 12 | turbine |
| 13 | rotational energy connecting | 14 | water management system |
| | element | | means |
| 15 | external heat exchanger | 16 | additional heat exchanger |
| | | | elements |

### DETAILED DESCRIPTION—PREFERRED EMBODIMENT

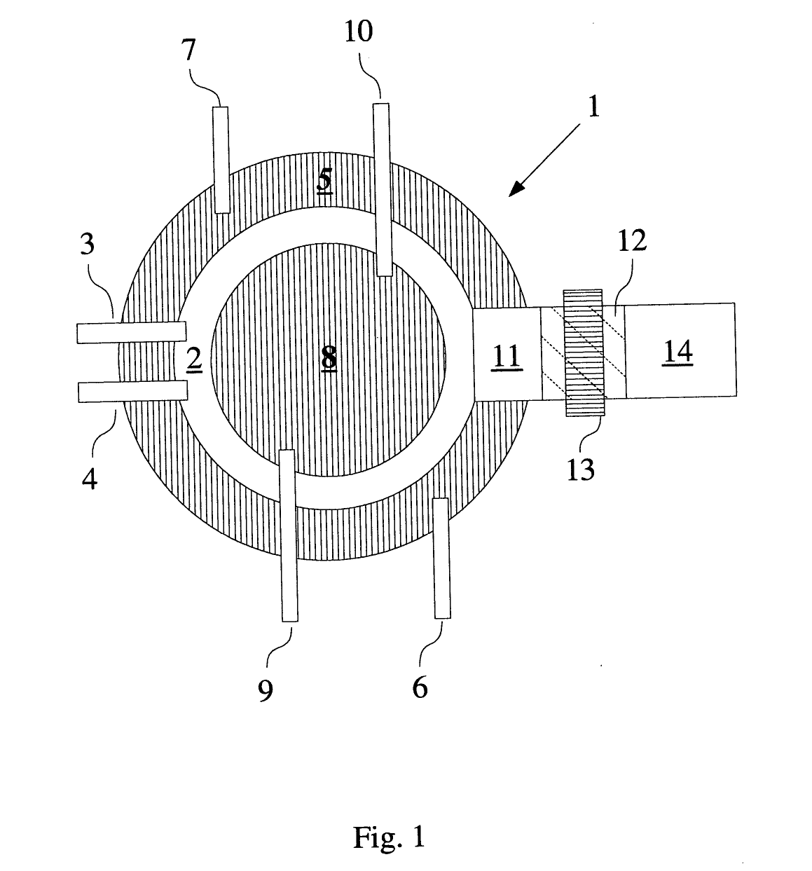

FIG. 1 shows a Dual Capture Jet Turbine 1 comprising: a combustion chamber 2 with attached nozzle 11, turbine 12, heat exchangers 5 and 8, together with a means of water recovery from the hydrogen oxygen reaction 14.

The two injectors, one each for hydrogen 3 and oxygen 4, are optimally located within the combustion chamber 2 to produce the maximum possible amount of energy.

Hydrogen, in liquid or gas form, may be obtained from pipelines, or storage tanks, not shown. A plurality of hydrogen sources will provide for fault tolerance. Oxygen in gas form may be obtained directly from the atmosphere, or via pipeline or storage tanks in either gas or liquid form, not shown.

Immediately adjacent to the hydrogen 3 and oxygen 4 injectors, and located within the combustion chamber 2 itself, is a heat exchanger 8. The said interior heat exchanger 8, a.k.a steam generator and shown in FIG. 1, is similar to those found in steam engines. Attached to heat exchanger 8 is a water injector 9 and a conduit for the steam generated 10. The steam is subsequently distilled, not shown, and returned to the water injector 9. Said steam is generated from water or another more suitable substance.

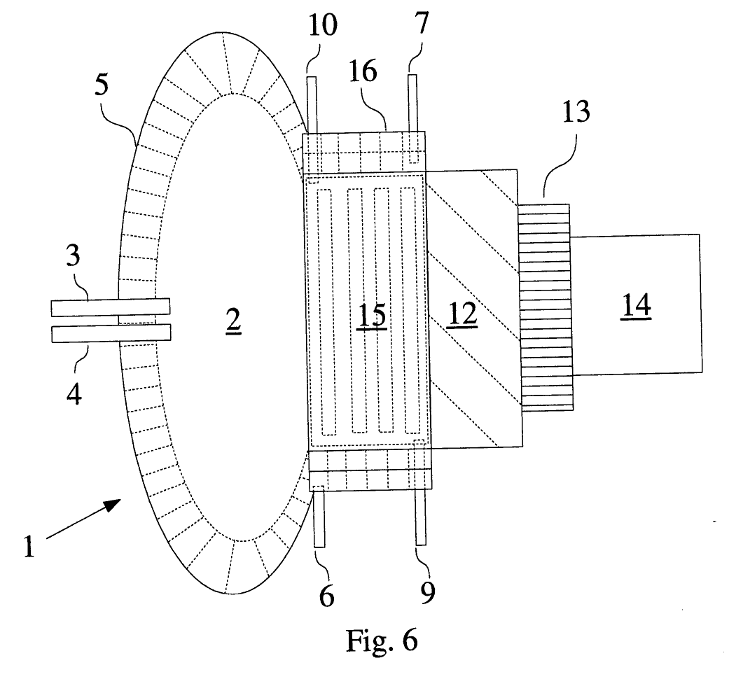

The exterior heat exchanger's elements S in FIG. 1 are arranged, perhaps coiled, for optimal heat recovery. Additional layers 16, as shown in FIG. 6, may by utilized to preheat water. The exterior heat exchanger 5 in FIG. 1 is similar in concept to the said interior heat exchanger 8 including the need for a water injector 6, a conduit for the steam generated 7, and a means to recycle the steam generated, also not shown.

The generated steam will most often replace the steam generated in electric power plants. The said steam is subsequently captured, distilled and returned to the water input means. This is a closed system and is not part of the water collection means 14 associated with the hydrogen oxygen reaction.

Attached to the opposing end of the combustion chamber 2 is a nozzle 11 to channel the generated thrust from the said combustion chamber 2 into a turbine 12. The turbine 12 may be attached to an electric generator, or other device that benefits from rotational energy, via a rotational energy connecting element 13.

Attached to the turbine 12 is a steam collection and water management system means 14 to capture the water resulting from the aforementioned hydrogen oxygen reaction.

Transmission/gear boxes, not shown, that engage and disengage the steam and thrust turbines with electric generators, will allow for water production when the demand for water exceeds that of electricity.

Initially the facilities for housing this invention, and its supporting apparatus, may be located near hydrogen production facilities. Once a national hydrogen pipeline infrastructure is in place the described jet turbine will then be able to replace existing steam generators in electric power plants, making possible a new readily available and environmentally friendly source of electric power and pure water.

### OPERATION OF INVENTON

Similar to the operation of a rocket engine and shown in FIG. 1 the Dual Capture Jet Turbine 1 combines hydrogen from the hydrogen injector 3 and oxygen from the oxygen injector 4 in the combustion chamber 2 to produce heat, thrust and water. The water from the reaction is channeled off to a water management system means 14 and utilized elsewhere. The heat from the said reaction is captured by the interior heat exchanger 8 and exterior heat exchanger 5 and transforms water or other suitable substance into steam or gas, respectively. The steam or gas is captured and transferred via conduits 7 and 10 to at least one turbine, not shown. Presumably the attached turbines will provide the rotational energy necessary for electric generators, also not shown. The steam or gas is then distilled and recycled, not shown, into the heat exchangers' water injectors 6 and 9. The thrust from the said reaction is captured by a nozzle 11 and directed to a turbine 12. The rotational energy produced by the turbine 12 is transferred by a rotational energy connecting element 13 and then transformed into electrical energy by an electric generator, not shown. Multiple turbines, not shown, may be necessary to fully capture all of the thrust produced. Ideally all that exits the system is a gentle cool breeze.

Power generated may be distributed on the national electric power grid, not shown, to offset the power necessary to generate the hydrogen consumed by the Dual Capture Jet Turbine 1, thus forming a complete circuit.

Should the demand for water exceed the demand for electricity, then the electric generator or generators may be disengaged by means of a transmission/gear box or boxes, not shown. Steam will most likely need to continue to be recycled in order to cool the system.

### DESCRIPTION AND OPERATION OF ALTERNATIVE EMBODIMENTS

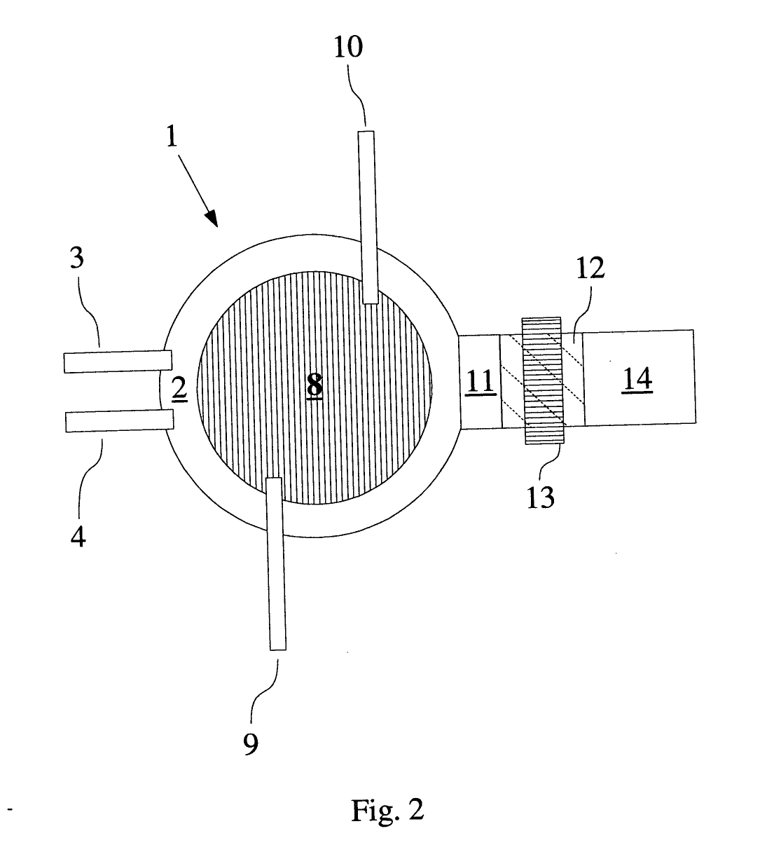

FIG. 2 shows a combustion chamber 2 with an interior heat exchanger 8 and an external turbine 12. Absent is an exterior heat exchanger. The operation of the system remains the same.

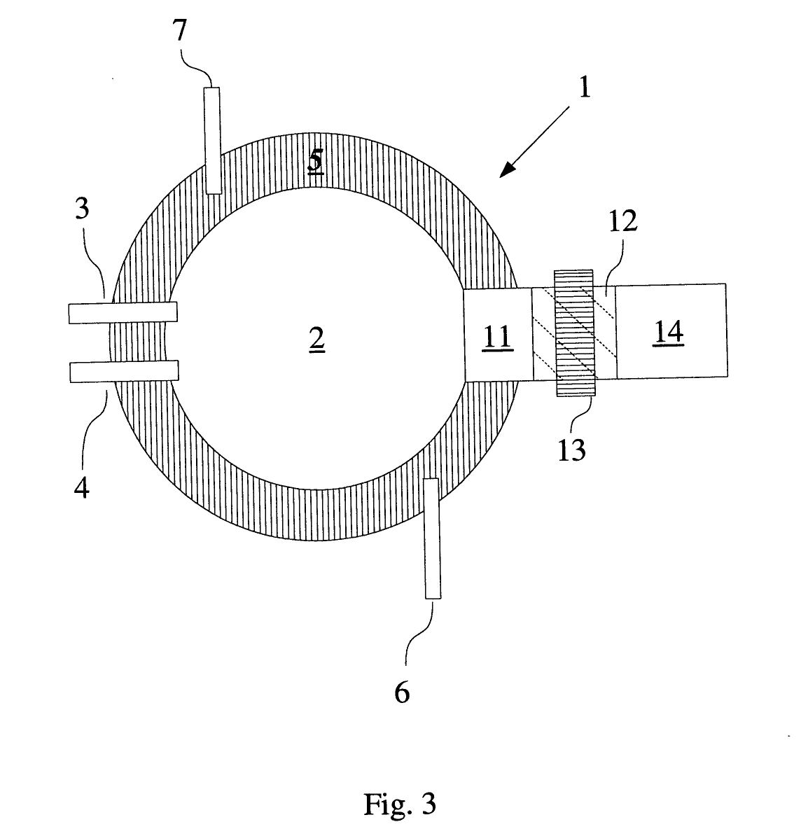

FIG. 3 shows a combustion chamber 2 with an exterior heat exchanger 5 and an external turbine 12. Absent is an interior heat exchanger. The operation of the system remains the same.

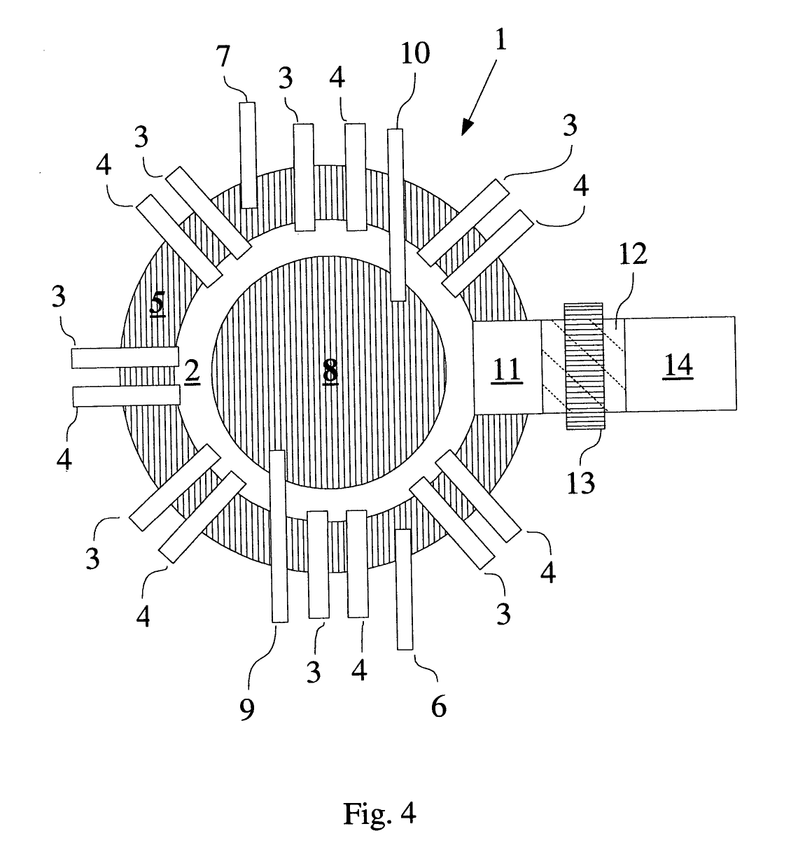

FIG. 4 shows a combustion chamber 2 with plurality of hydrogen 3 and oxygen 4 input pairs. Such an array of injectors will likely increase the total amount of heat and thrust generated. The said array of oxygen and hydrogen injectors may be incorporated into any combination of the previous or following heat exchanger configurations. The operation of the system remains the same.

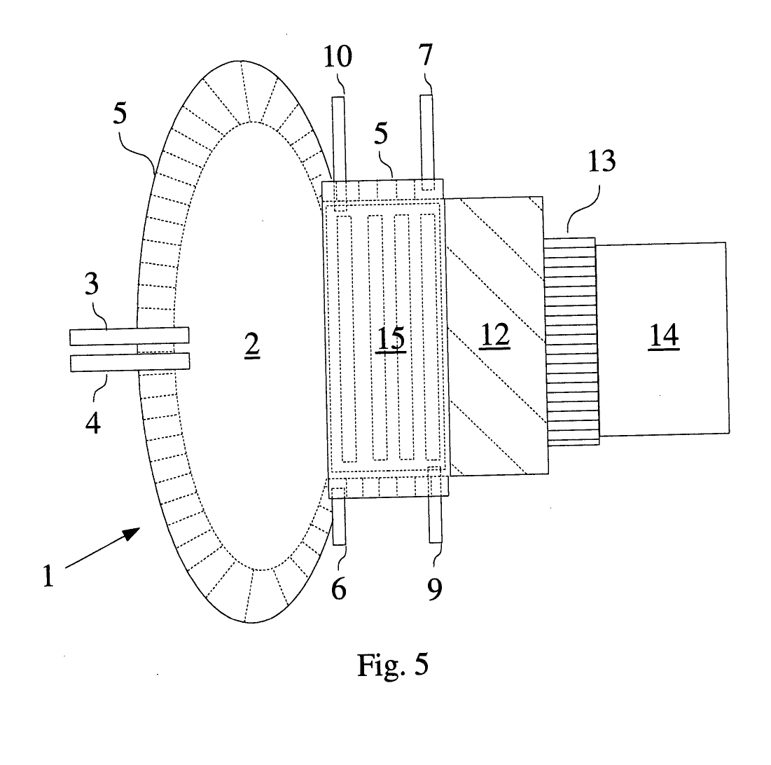

FIG. 5 shows a combustion chamber 2 with the external heat exchanger 15 installed adjacent to the combustion chamber 2 with an exterior heat exchanger 5 surrounding it. The operation of the system remains the same.

FIG. 6 shows a combustion chamber 2 with the external heat exchanger 15 installed adjacent to the combustion chamber 2 with an exterior heat exchanger 5 surrounding it. Unique to this figure are the multiple layers of heat exchanger elements 16 that allow for the preheating of water or other substance prior to injection into a heat exchanger. These additional layers may be added to any of the previously stated configurations. The operation of the system remains the same.

### CONCLUSION, RAMIFICATIONS, AND SCOPE

Thus the reader will see that this invention provides for an environmentally friendly means of producing steam and thrust to be later transformed into electricity and water.

The invention will be of interest to utility companies who can reduce costs, eliminate hazardous emissions and improve public relations by incorporating nontoxic solutions. Consumers will enjoy a safer, cleaner, more affordable and readily available source of water and power.

A plurality of hydrogen sources will provide fault tolerance in the event of a severed pipeline or other catastrophic event, thus avoiding any disruption of water and power delivery.

The shape of the combustion chamber may be transformed into more than just the circular and oval configurations shown here. It could, for example, take the form of an oval, but unlike the oval combination chamber depicted in FIGS. 5 and 6, it might house an interior heat exchanger.

The exterior heat exchangers, as previously described, may instead preheat water or other substance prior to injection into an interior heat exchanger, rather than as a source of steam for a steam driven turbine.

All materials used in the fabrication of parts that may come into contact with the resultant water from the hydrogen and oxygen reaction must be nontoxic.

While my above description contains many specificities, these should not be construed as limitations on the scope of the invention, but rather as an exemplification of one preferred embodiment thereof.

Accordingly, the scope of the invention should be determined not by the embodiments illustrated, but by the appended claims and their legal equivalents.

1. A hydrogen powered jet turbine steam generator comprising:
a combustion chamber for a hydrogen oxygen reaction;
at least one heat exchanger to capture the resultant heat from said hydrogen oxygen reaction in said combustion chamber;
at least one turbine to capture the thrust generated from said hydrogen oxygen reaction in said combustion chamber;
whereby producing energy in an environmentally friendly manner.

2. The hydrogen powered jet turbine steam generator as claimed in claim 1, further comprising a means of capturing the water resulting from said hydrogen oxygen reaction;
whereby producing pure water in an environmentally friendly manner.

3. The water capturing means as claimed in claim 2, wherein said water capturing means is a means of distillation.

4. The combustion chamber as claimed in claim 1, wherein said combustion chamber is made of stainless steel.

5. The combustion chamber as claimed in claim 1, further comprising at least one means to inject said hydrogen into said combustion chamber.

6. The hydrogen injection means as claimed in claim 5, wherein said hydrogen injection means is a plurality of hydrogen injection means.

7. The hydrogen injection means as claimed in claim 5, wherein said hydrogen is obtained via pipeline.

8. The hydrogen injection means as claimed in claim 5, wherein said hydrogen is obtained from a storage means.

9. The combustion chamber as claimed in claim 1, further comprising at least one means to inject said oxygen into said combustion chamber.

10. The oxygen injection means as claimed in claim 9, wherein said oxygen injection means is a plurality of said oxygen injection means.

11. The oxygen injection means as claimed in claim 9, wherein said oxygen is obtained from the atmosphere.

12. The oxygen injection means as claimed in claim 9, wherein said oxygen is obtained from a pipeline.

13. The oxygen injection means as claimed in claim 9, wherein said oxygen is obtained from a storage means.

14. The heat exchanger as claimed in claim 1, wherein said heat exchanger is made from stainless steel.

15. The heat exchanger as claimed in claim 1, wherein said heat exchanger is located within the interior of said combustion chamber.

16. The interior heat exchanger as claimed in claim 15, further comprising a steam driven turbine.

17. The steam driven turbine as claimed in claim 16, further comprising a means to recycle said steam.

18. The steam driven turbine as claimed in claim 16, further comprising a transmission/gear box to engage or disengage the the said turbine with an electric generator.

19. The heat exchanger as claimed in claim 1, wherein said heat exchanger is surrounding the exterior of the said combustion chamber.

20. The exterior heat exchanger as claimed in claim 19 further comprising a steam driven turbine.

21. The steam driven turbine as claimed in claim 20, further comprising a means to recycle said steam.

22. The steam driven turbine as claimed in claim 20, further comprising a transmission/gear box to engage or disengage the the said turbine with an electric generator.

23. The heat exchanger as claimed in claim 1, wherein said heat exchanger is in combination an interior heat exchanger and an exterior exchanger.

24. The turbine as claimed in claimed in claim 1, wherein said turbine is made from stainless steel.

25. The turbine as claimed in claimed in claim 1, wherein said turbine is a Hollow Turbine, patent pending.

26. The turbine as claimed in claimed in claim 1, wherein said turbine is a steam turbine.

27. A method for replacing the hydrocarbon and uranium fired steam generators used in electric power plants comprising:
combining hydrogen and oxygen in a combustion chamber;
capturing the resulting heat and thrust from said hydrogen oxygen reaction;
channeling said thrust and heat to turbines;
whereby producing energy in an environmentally friendly manner.

28. The method of replacing the hydrocarbon and uranium fired steam generators as claimed in claim 27, further comprising at least one electric generator;

29. The method of replacing the hydrocarbon and uranium fired steam generators as claimed in claim 27, further comprising a method of capturing the resulting water from the said hydrogen oxygen reaction;

30. The channeling means as claimed in claim 27, further comprising at least one heat exchanger;

31. The channeling means as claimed in claim 27, further comprising at least one nozzle;
whereby electricity and pure water may be produced from a single hydrogen carrying means, conceivably a single pipeline or a plurality of said pipelines for fault tolerance, in an environmentally friendly manner;
whereby the hydrocarbon and uranium fired steam generators used in electric power plants may be replaced with a pollution free alternative technology with minimal disruption to existing electricity generation;
whereby providing for a seamless switch-over from current technologies;
whereby a communities' water supply could be supplemented by or provided entirely from an environmentally friendly source.

32. A method of producing electricity comprising:
providing a combustion chamber for a hydrogen oxygen reaction;
providing at least one turbine;
providing at least one electric generator;
whereby producing electricity in an environmentally friendly manner.

33. The method of producing electricity as claimed in claim 31, further comprising at least one heat exchanger.

34. A method of producing water comprising:
providing a combustion chamber for a hydrogen oxygen reaction;
providing at least one water management system means;
whereby producing water in an environmentally friendly manner.

35. The water management system means as claimed in claim 33, wherein said water management means is distillation.
